(19) United States
(12) Patent Application Publication
(10) Pub. No.: US 2011/0036802 A1
(43) Pub. Date: Feb. 17, 2011

(54) PERFUME BOTTLE

(75) Inventors: Herve Ronsin, Malestroit (FR); Fabrice Soulard, Fay Aux Loges (FR)

Correspondence Address: SUGHRUE MION, PLLC, 2100 PENNSYLVANIA AVENUE, N.W., SUITE 800, WASHINGTON, DC, 20037, US

(73) Assignee: SHISEIDO INTERNATIONAL FRANCE, Paris (FR)

(21) Appl. No.: 12/988,480

(22) PCT Filed: Apr. 10, 2009
(86) PCT No.: PCT/FR09/50677

§ 371 Date: Oct. 18, 2010

(30) Foreign Application Priority Data
Apr. 18, 2008 (FR) 0852643

(51) Int. Cl. B65D 23/02; B05D 3/06; B05D 7/22; B05D 3/02; B05D 3/10

(52) U.S. Cl. 215/12.2; 427/555; 427/230

(57) ABSTRACT

A perfume bottle comprising a body (1) and a neck (2), the body (1) defining a perfume reservoir (10) that is delimited by an inside surface (14), the body being made of material that is substantially transparent, such as glass, the bottle being characterized in that the inside surface (14) is coated, at least in part, with a reflective layer (Cm) that imparts a mirror effect, the layer (Cm) being visible and reflective through the transparent material that constitutes the body, the perfume coming into direct contact with the layer (Cm).

The present invention relates to a perfume bottle as used in the field of perfumery, or in the field of cosmetics. The term perfume should be understood in its broadest sense, naturally encompassing perfumes in the strict sense, i.e. a fragrant liquid of low viscosity, but also other types of fragrant liquid of low or medium viscosity, such as eau de toilette, lotions, e.g. aftershave, gels, etc. The present invention also relates to a method of decorating such a perfume bottle.

In general, perfume bottles are made of glass, but they may equally well be made of other materials such as plastics materials or metal, for example. In the context of the present invention, attention is directed more particularly to perfume bottles that are substantially or completely transparent, i.e. made of one or more materials that enable light to pass therethrough. Naturally, the preferred material is glass that is colorless (i.e. clear), or colored only very slightly.

The present invention also relates to a perfume bottle in which the bottle body that forms the perfume reservoir, has an inside surface that is in direct contact with the perfume. In other words, the perfume is not contained in a barrier container, such as a pouch or an internal reservoir that is separate from the inside surface so that there is no contact between the perfume and the inside surface. In the present invention, because the perfume is in contact with the inside surface, it must not react with the surface, e.g. by extracting or releasing components.

In the prior art, perfume bottles are already known having an inside surface that is coated with a lacquer or a varnish. However, the perfume is contained in a flexible pouch that is inserted into the reservoir. In this way, the perfume does not come into contact with the layer of lacquer or varnish, so as to avoid any interaction between the perfume and the components of the layer of lacquer or varnish. In any event, in that type of internally lacquered or varnished bottle, it is not possible to see the perfume inside the reservoir, firstly because the lacquer or the varnish covers the entire inside surface of the reservoir, and secondly because the flexible pouch containing the perfume is opaque and unattractive.

An object of the present invention is to provide another way of decorating a perfume bottle that does not require the use of a flexible pouch or of a barrier container separating the perfume from the inside surface of the bottle. Another object of the present invention is to provide decoration that does not react with the perfume. Still another object of the present invention is to provide a decorated, transparent perfume bottle through which the perfume can be seen inside the reservoir.

To achieve the various objects, the present invention proposes a perfume bottle comprising a body and a neck, the body defining a perfume reservoir that is defined by an inside surface, the body being made of material that is substantially transparent, such as glass, the bottle being characterized in that the inside surface is coated, at least in part, with a reflective layer that imparts a mirror effect, the layer being visible and reflective through the transparent material that constitutes the body, the perfume contained in the bottle advantageously coming into direct contact with the reflective layer.

Advantageously, the layer is a layer of silvering, essentially constituted by silver ions. In a variant, the reflective layer may be made up of a layer of gold, copper, zinc, oxidized silver, etc., or more generally of a metal having oxidation-reduction properties.

Advantageously, the inside surface is provided with a plurality of layer zones that are separated by non-coated bare zones through which the perfume is visible in the reservoir. Thus, the inside surface of the reservoir is coated, at least in part, with a layer of silvering that imparts a conventional colorless-mirror effect. Where the inside surface is not coated with the mirror layer, it is possible to see the perfume inside the reservoir. It should be kept clearly in mind that the perfume comes into direct contact with the mirror layer. This is why it is particularly advantageous to use silvering that is essentially constituted by silver ions that have the neutral, anti-bacterial, and anti-allergenic qualities that have been well known for a long time. It has been found in empirical manner that perfume, whatever its nature and its composition, does not interact in detrimental manner with silver. In addition, it is also known that silver is particularly well accepted by most skins. Consequently, even if the perfume does contain a few traces of silver, there is no danger in applying the perfume to the skin.

In another aspect of the invention, the bottle includes an outside surface that may be coated, at least in part, with a varnish that is filled with fine color particles for visually changing the color of the internal mirror layer.

When the reflective layer is not compatible with being in contact with the perfume, it is envisaged to cover the reflective layer with a sol-gel layer that comes into direct contact with the perfume.

The present invention also defines a method of decorating a perfume bottle comprising a body and a neck, the body defining a perfume reservoir that is defined by an inside surface, the body being made of material that is substantially transparent, such as glass, the bottle being characterized in that a reflective layer is applied to the inside of the reservoir on its inside surface.

Advantageously, the layer is a layer of silvering, essentially constituted by silver ions. In a variant, the reflective layer may be a layer of gold, copper, zinc, oxidized silver, etc., or more generally of a metal having oxidation-reduction properties.

Preferably, a reducing solution of AgNO₃ is applied to the inside surface so as to form the layer.

According to an advantageous characteristic of the invention, an activator such as tin chloride and/or an adhesion promoter such as palladium chloride is applied to the inside surface prior to applying the layer. It has been found in empirical manner that this prior activator and/or adhesion-promoter treatment makes it possible to ensure that the layer of silvering adheres properly on the inside surface of the reservoir. In the absence of this treatment step, the mirror layer degrades by unsticking and/or flaking on contact with the perfume.

According to another advantageous characteristic, the bottle, with its layer already applied thereto, is subjected to a temperature lying in the range about 150° C. to 190° C. for a period lying in the range about 20 minutes (min) to 60 min. Such baking makes it possible to eliminate any traces of water and of reducing salts resulting from chemical reaction, and thereby to obtain a layer of pure silver on the glass that is stable in position and that possesses sufficient chemical inertness on coming into contact with perfume.

In another advantageous aspect of the present invention, a fraction of the layer is removed from the inside surface, so as to form non-coated bare zones through which the perfume is visible in the reservoir.

Advantageously, a laser is used to remove the layer, the laser reaching the layer from the outside of the bottle, through the material that constitutes the body. Preferably, the laser is a YAG-type fiber laser. Removing part of the mirror layer makes it possible to create interesting decoration or attractive esthetic effects. Part of the mirror layer may be removed using any technique, but the use of a laser, preferably a YAG-type fiber laser, has been found to be particularly effective and easy to use, given that it is manipulated from outside the bottle, causing the laser beam to pass through the material that constitutes the body.

In another aspect, the outside surface of the bottle is covered, at least in part, with a varnish that is filled with fine color particles.

A principle of the present invention is to use silver, or some other metal, known for its qualities of neutrality and inertness, in order to constitute a layer on the inside surface of a perfume bottle, so that direct contact between the perfume and the mirror layer is possible. Another principle of the present invention is to treat the inside surface of the reservoir beforehand and/or subsequently, so that the silver mirror layer does not degrade on contact with the perfume. Finally, still another principle of the present invention is to use a laser to strip away the mirror layer, said laser operating from the outside, through the thickness of the material of the bottle.

The invention is described more fully below with reference to the accompanying drawings which show an embodiment of the invention by way of non-limiting example.

In the figures:

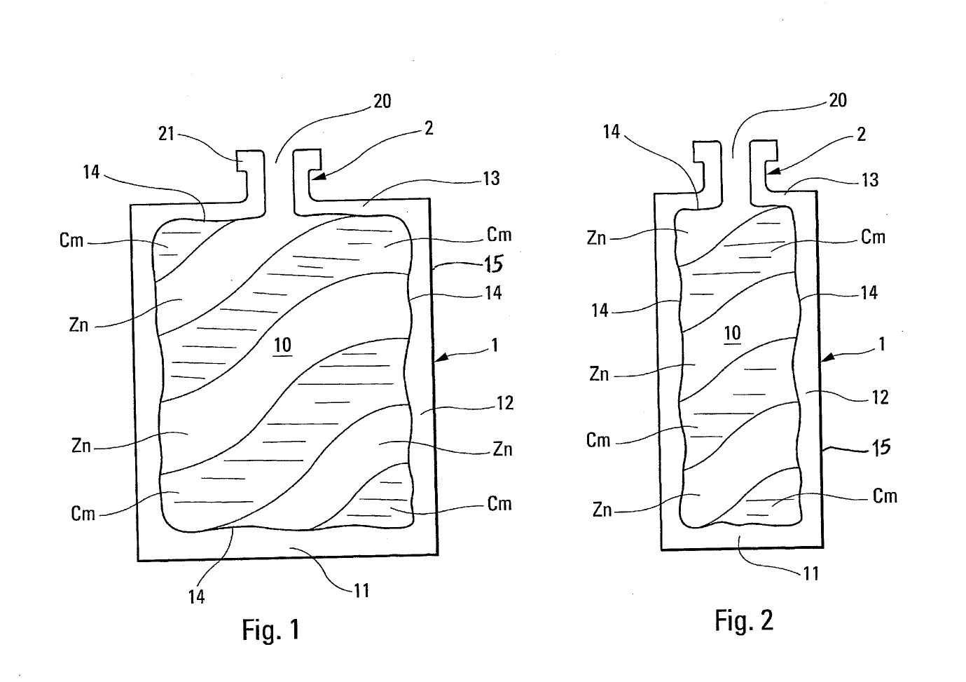

FIG. 1 is a diagrammatic front view of a perfume bottle made in accordance with the invention; and

FIG. 2 is a side view of the FIG. 1 bottle.

In conventional manner, the perfume bottle in FIGS. 1 and 2 comprises a body 1 and a neck 2. The body 1 internally defines a constant working volume that serves as a perfume reservoir 10. The reservoir 10 is defined by an inside surface 14 that is continuous, except at the neck 2 that defines an opening 20 that puts the perfume reservoir 10 into communication with the outside. The body 1 comprises a bottom wall 11, four side walls 12, and a top wall or shoulder 13 from which the neck 2 extends. The inside surface 14 is formed by the inside surfaces of the bottom wall 11, the side walls 12, and the shoulder 13. In the non-limiting embodiment used to illustrate the present invention, the body 1 of the bottle presents a shape that is generally a rectangular parallelepiped. The same applies for the reservoir 10. However, without going beyond the ambit of the invention, it is possible to envisage any geometrical or complex shape for the body 1 and its internal reservoir 10. By way of example, the body 1 may be completely circularly-cylindrical about an axis, or it may even be in the form of the most divers objects, e.g. an apple, a piece of bamboo, etc. In other words, the shape of the body 1 and of its internal reservoir 10 is not critical for the present invention.

However, some or all of the body 1 is made from one or more materials that is/are substantially or completely transparent or translucent, such that it is possible to see the perfume inside the reservoir 10 through a side wall 12, the bottom wall 11, and/or the shoulder 13. By way of example, the body 1 may be entirely transparent and colored or colorless. It is also possible to make the neck 2 out of a material that is substantially or completely transparent. As a constituent material for making the body 1 and possibly the neck 2, it is possible to use colored or colorless glass, or even a transparent plastics material, such as a polycarbonate, for example. However, in the context of the invention, glass is preferred.

The bottle shown in FIGS. 1 and 2 is normally associated with a dispenser member, such as a pump, so that together they constitute a fluid dispenser. The pump is mounted in the opening 20 of the neck 2 and is fastened in leaktight manner by a fastener ring that comes into engagement with the neck 2 that is formed with an annular rim 21 for this purpose. The pump preferably includes a dip-tube that extends inside the reservoir into the proximity of its bottom wall 11. In addition, the pump includes a pusher that may be actuated axially by means of one or more fingers, so as to dispense doses of fluid. Advantageously, the pusher is provided with a nozzle making it possible to spray the perfume.

In the invention, the inside surface 14 of the reservoir 10 is coated, at least in part, with a reflective layer Cm that imparts a mirror effect. Given that the body 1 is transparent, the layer Cm is visible through the thickness of the wall of the body 1. The mirror effect may thus be observed through the side walls 12, the bottom wall 11, and/or the shoulder 13. The layer Cm may also extend inside the neck 2. Advantageously, the reflective layer Cm is a layer of silvering, essentially constituted by silver ions. A layer Cm may also be formed of gold, copper, zinc, oxidized silver, etc., or more generally of a metal having oxidation-reduction properties.

Attempts to apply layers of metallization to the inside surface 14 have ended in failure: amongst other things, it is impossible to use a vacuum spraying or sputtering technique to apply a layer of metal to the inside surface 14 because of the small dimension of the opening 20 formed by the neck 2. The diameter of the opening 20 lies in the range only about 10 millimeters (mm) to about 20 mm. The advantage with the layer of silvering is that it does not require the use of such a vacuum spraying or sputtering technique. The layer of silvering may be applied at atmospheric pressure, merely by coating the inside surface 14 with a reducing solution of AgNO₃, e.g. by shaking the bottle. In addition, the use of most sprayable metals is incompatible with perfume because they react interactively. Perfume filled with traces of such metals may even be harmful to the user's health. This is not the situation with silver, which is known for its neutral, inert, anti-bacterial, and anti-allergenic qualities. Even if traces of silver are present in the perfume, there is no danger to the user.

This is why silver presents two advantages, namely those of being easy to apply and of being neutral.

However, in order to guarantee proper adhesion of the layer of silvering on the inside surface 14, it is preferable to subject the inside surface 14 to a prior treatment. By way of example, it is possible to apply an activator, such as tin chloride, to the inside surface 14 of the reservoir. It is also possible to apply an adhesion promoter, such as palladium chloride, to the inside surface 14 of the reservoir. Before, between, and after each application, it is preferable to rinse the reservoir 10 thoroughly. Then, the liquid silvering, that is constituted by a reducing solution and by a solution of AgNO₃, is poured into the reservoir 10 through the opening 20. In order to enable the silvering to be distributed in uniform manner, the perfume bottle is agitated or shaken. Any excess silvering is poured out. The silvering, which is constituted by a silver salt, transforms into silver ions on the inside surface 14. After drying, a reflective mirror layer is obtained, essentially constituted by silver ions. The reflective mirror layer preferably extends over the entire inside surface 14. However, it is possible to apply the layer over a fraction only of the inside surface.

After the silvering operation, it is necessary to empty the bottle, then rinse it with distilled water, and pass it into a baking oven at a temperature lying in the range 150° C. to 190° C. for a period lying in the range 20 min to 60 min, so as to eliminate any traces of water and of reducing salts resulting from chemical reaction, and thereby to obtain a layer of pure silver on the glass that is stable in position and that possesses sufficient chemical inertness on coming into contact with perfume.

In the invention, it is possible to remove a fraction of the reflective mirror layer, so as to form non-coated bare zones Zn through which the perfume is visible in the reservoir 10. In FIGS. 1 and 2, the reflective layer Cm extends in the form of undulating strips that are separated by undulating strips of non-coated bare zones Zn. In other words, the layer zones Cm are separated by bare zones Zn. Naturally, this is only one particular non-limiting configuration: it is possible to remove the layer Cm in a wide variety of patterns, so as to impart particular attractive appearances thereto. However, it is necessary that the removal of part of the layer Cm does not create fragile or flaky edges that would quickly spoil the perfume. In addition, flaky edges would not be very attractive. In order to remove the layer Cm, in part, any technique may be used, but the use of a laser, preferably a YAG-type fiber laser, has been found to be particularly appropriate, in particular because of its high accuracy of about 30 micrometers (μm). The YAG-type fiber laser leaves layers Cm with edges that are completely sharp, and as a result are very capable of withstanding perfume. Other types of laser may be used, but tests have proven that the YAG-type fiber laser offers the highest performance. Another advantage of the laser is that the movement of the beam may be controlled easily by appropriate software, thereby making it possible to create very complex patterns in the layer Cm.

It should also be observed that the laser is used from the outside of the reservoir 10, and not from the inside thereof, with the beam being directed onto the reflective layer Cm through the thickness of the wall of the body 1. Using the laser externally makes it very easy to manipulate, and offers the possibility of using conventional lasers that, because of the constricted opening of the neck, cannot be used if the laser stripping operation needs to be performed from the inside of the reservoir 10. This characteristic may be used for other laser treatments of various internal coatings that are applied to the inside surface of the bottle.

Naturally, the bottle includes an outside surface 15 that may be coated, at least in part, with a varnish that is filled with fine color particles that may be metal, or that may be in the form of pigment. The color of the mirror layer Cm may thus be changed visually, which layer may advantageously be a layer of silver.

The perfume preferably comes into direct contact with the reflective layer. However, when the reflective layer is not compatible with being in contact with the perfume, it is envisaged to cover the reflective layer with a sol-gel layer that comes into direct contact with the perfume. Sol-gels are inert vitreous materials that are obtained without recourse to melting.

The present invention thus makes it possible to form a reflective decoration inside a perfume reservoir for directly containing perfume, without risk of deteriorating the perfume or of damaging the user's health.

1. A perfume bottle comprising a body and a neck, the body defining a perfume reservoir that is defined by an inside surface, the body being made of material that is substantially transparent, such as glass, the bottle being characterized in that the inside surface is coated, at least in part, with a reflective layer (Cm) that imparts a mirror effect, the layer (Cm) being visible and reflective through the transparent material that constitutes the body.

2. A perfume bottle according to claim 1, wherein the layer (Cm) is a layer of silvering, essentially constituted by silver ions.

3. A perfume bottle according to claim 1, wherein the reflective layer (Cm) is a layer of a metal having oxidation-reduction properties, such as gold, copper, zinc, oxidized silver.

4. A perfume bottle according to claim 1, wherein the inside surface is provided with a plurality of layer zones (Cm) that are separated by non-coated bare zones (Zn) through which the perfume is visible in the reservoir.

5. A perfume bottle according to claim 1, including an outside surface that is coated, at least in part, with a varnish that is filled with fine color particles.

6. A perfume bottle according to claim 1, filled with perfume, the perfume coming into direct contact with the layer (Cm).

7. A perfume bottle according to claim 1, wherein the reflective layer (Cm) is covered with a sol-gel layer that comes into direct contact with the perfume.

8. A method of decorating a perfume bottle comprising a body and a neck, the body defining a perfume reservoir that is defined by an inside surface, the body being made of material that is substantially transparent, such as glass, the bottle being characterized in that a reflective layer (Cm) is applied to the inside of the reservoir on its inside surface.

9. A decorating method according to claim 8, wherein the layer (Cm) is a layer of silvering, essentially constituted by ions of silver, gold, copper, zinc, oxidized silver, or any other metal element having oxidation-reduction properties.

10. A decorating method according to claim 8, wherein a reducing solution of AgNO₃ is applied to the inside surface so as to form the layer (Cm).

11. A decorating method according to claim 8, wherein an activator, such as tin chloride, and/or an adhesion promoter, such as palladium chloride, is applied to the inside surface prior to applying the layer (Cm).

12. A decorating method according to claim 8, including subjecting the bottle, with its layer (Cm), to a temperature lying in the range about 150° C. to 190° C. for a period lying in the range about 20 min to 60 min.

13. A decorating method according to claim 8, including coating, at least in part, an outside surface of the bottle with a varnish that is filled with fine color particles.

14. A decorating method according to claim 8, wherein a fraction of the layer (Cm) is removed from the inside surface, so as to form non-coated bare zones (Zn) through which the perfume is visible in the reservoir.

15. A decorating method according to claim 14, wherein a laser is used to remove the layer (Cm), the laser reaching the layer (Cm) from the outside of the bottle through the material that constitutes the body, the laser being a YAG-type fiber laser.

16. A decorating method according to claim 8, wherein a sol-gel layer is applied to the reflective layer (Cm).
